(19) United States
(12) Patent Application Publication
(10) Pub. No.: US 2016/0057688 A1
(43) Pub. Date: Feb. 25, 2016

(54) HANDLING UPLINK/DOWNLINK IMBALANCE

(71) Applicant: NOKIA CORPORATION, Espoo (FI)

(72) Inventors: Jussi-Pekka Koskinen, Oulu (FI); Jarkko Koskela, Oulu (FI); Jorma Kaikkonen, Oulu (FI); Lars Dalsgaard, Oulu (FI)

(73) Assignee: Nokia Technologies Oy, Espoo (FI)

(21) Appl. No.: 14/780,815

(22) PCT Filed: Mar. 14, 2014
(86) PCT No.: PCT/FI2014/050188

§ 371 Date: Sep. 28, 2015

Related U.S. Application Data
(60) Provisional application No. 61/809,204, filed on Apr. 5, 2013.

(51) Int. Cl. H04W 36/30; H04W 74/08; H04W 36/08

(52) U.S. Cl. CPC H04W 36/30; H04W 36/08; H04W 74/0833

(57) ABSTRACT

Methods and apparatus, including computer program products, are provided for internetworking. In some example embodiments, there is provided a method. The method may include detecting, by a user equipment camped on a cell, a non-responsive base station with respect to a random access procedure performed by the user equipment; and enabling the user equipment to search for another cell, rather than remaining camped on the cell. Related apparatus, systems, methods, and articles are also described.

### FIELD

The subject matter disclosed herein relates to wireless communications.

### BACKGROUND

A wireless device, such as a user equipment, may camp on a first cell served by a first wireless access point, such as a first base station. The user equipment may camp on cell located at a relatively long distance away from the user equipment. This may happen for example due terrain/lakes effects, Node B elevation and the like providing more favorable propagation conditions than typically assumed in network planning. When this is the case, the user equipment may receive signaling messages from the controlling base station, and these messages may include for example a system information block and/or other information. However, the messages sent by the user equipment to the controlling base station may not be received by the controlling base station. For example, the user equipment may send, while camped at the first cell, random access burst messages to the controlling base station but due to power limitations at the user equipment, distance to the controlling base station, and the like, these messages may not be received by the controlling base station. However, according to the current Evolved Universal Terrestrial Radio Access Network (E-UTRAN) specification (for example, TS 36.304 and 36.331), the user equipment remains camped on the first cell (which is also served by the first wireless access point), although the network is not responding to random access preambles transmitted by the user equipment. The user equipment waits to change the cell when a cell (re)selection criteria is fulfilled. As such, the user equipment may remain “stuck” on the cell, without being allocated an uplink/downlink or without being able to contact the cell in uplink or respond to the messages sent by the cell.

### SUMMARY

Methods and apparatus, including computer program products, are provided for internetworking. In some example embodiments, there is provided a method. The method may include detecting, by a user equipment camped on a cell, a non-responsive base station with respect to a random access procedure performed by the user equipment; and enabling the user equipment to search for another cell, rather than remaining camped on the cell.

In some variations, one or more of the featured disclosed herein including one or more of the following features can optionally be included in any feasible combination The method may further include barring from the search at least one of a frequency associated with the cell, the cell, or a radio access technology associated with the cell. The barring may be performed for a predetermined period of time. The user equipment may be configured to perform the barring based on at least one of signaling received from the network or a default configuration. The user equipment may search for the other cell using at least one of another frequency or another radio access technology. The detecting may further include detecting that the non-responsive base station fails to respond to a transmission by the user equipment of one or random access requests. The detecting may further determining at least one of the following: whether a predetermined quantity of random access requests sent to the non-responsive base station fails to result in a response from the non-responsive base station; whether the non-responsive base station fails to respond to random access messages after a predetermined duration; and whether a path loss estimate between the user equipment and the non-responsive base station exceeds a predetermined threshold. The user equipment may perform the search for another cell, another frequency, another radio access technology, or a combination thereof, when the non-responsive base station does not response to one or more random access requests transmitted by the user equipment. The equipment may perform the search for another cell, another frequency, another radio access technology, or a combination of thereof, when a measurement associated with the non-responsive base station exceeds a threshold value, wherein the measurement represents at least one of a reference signal received power, a received signal strength indication, or a reference signal received quality. The user equipment may perform the search for another cell, another frequency, another radio access technology, or a combination thereof, when a network configures the user equipment to perform the search after a random access failure with the non-responsive base station. The user equipment may be enabled to perform the search for another cell by at least applying an offset for a received signal quality metric for at predetermined time. The user equipment may be enabled to perform the search for another cell by at least adjusting a priority of the cell. The user equipment may be enabled to perform the search for another cell by at least selecting away from the cell. The user equipment may be enabled to perform the search for another cell by accessing a list prohibiting access to the cell.

Articles are also described that comprise a tangibly embodied computer-readable medium embodying instructions that, when performed, cause one or more machines (for example, computers) to result in operations described herein. Similarly, apparatus are also described that can include a processor and a memory coupled to the processor. The memory can include one or more programs that cause the processor to perform one or more of the operations described herein.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIG. 1 depicts an example of a system including a user equipment camped on a cell, in accordance with some example embodiments;

FIG. 2 depicts an example of a process for barring by the user equipment a frequency, a cell, and/or a radio access technology to enable the user equipment to stop camping on a cell and search for another cell, in accordance with some example embodiments;

FIG. 3 depicts an example of an apparatus that may be used as a user equipment, in accordance with some example embodiments; and

FIG. 4 depicts an example of a base station, in accordance with some example embodiments.

Like labels are used to refer to same or similar items in the drawings.

### DETAILED DESCRIPTION

In some example embodiments, the subject matter disclosed herein prevents a user equipment camping on a cell from getting “stuck” on the cell by allowing the user equipment to detect non-responsive base station conditions and to search for another cell. In addition the UE may perform “barring” from using a frequency, a cell, and/or a radio access technology associated with the so-called “stuck” cell. In some example embodiments, the “stuck cell” may cause the UE for example declare a radio link failure in connected mode, and further searching the cell from other prompting a search for another frequency, a cell, and/or a radio access technology.

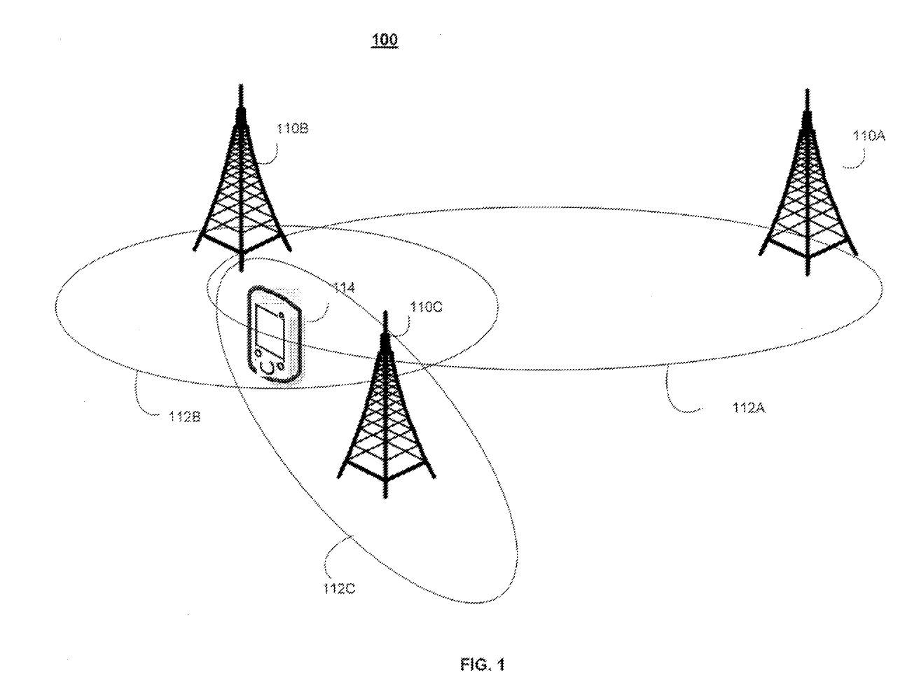

FIG. 1 depicts an example system 100 including a user equipment 114 camped, under the control of base station 110A, while situated at area of cell 1128, which is also served by wireless access points, such as base stations 110B-C. For example, base station 110A may be a macrocell base station, and base stations 110B-C may be small cell base stations, although other types of wireless access points and base stations may be implemented as well.

The user equipment 114 may detect a non-responsive condition, such as not receiving a certain response from the network including base station 110A controlling user equipment 114. For example, user equipment 114 may be able to receive transmissions from the base station transmitter 110A at higher signal level, but user equipment 114 may send one or more random accesses bursts to the base station 110A, but base station 110A may not receive these successfully and respond to the random access by user equipment 114. When this is the case, user equipment 114 may detect non-responsiveness with respect to base station 110A by detecting no received responses to one or more random accesses bursts.

In some example embodiments, user equipment 114 may transmit a certain quantity (for example, signaled or statically specified) of random access preambles or requests to base station 110A and if responses from base station 110A are not received, user equipment 114 may detect a non-responsive network/base station. Alternatively, or in addition, user equipment 114 may transmit the one or more random accesses bursts for a certain duration (for example, signaled or statically specified) 110A and if responses from base station 110A are not received, user equipment 114 may also detect a non-responsive network/base station. Alternatively, or in addition, user equipment 114 may use a certain (for example, maximum) power to transmit a random access preamble or request to base station 110A and if responses from base station 110A are not received, user equipment 114 may detect a non-responsive network/base station. Alternatively, or in addition, user equipment 114 may transmit a certain quantity of random access attempts (for example, as described in 3GPP TS 36.321), so that a quantity of random access bursts have been transmitted followed by re-initiation of the random access procedure, and if responses from base station 110A are not received, user equipment 114 may also detect a non-responsive network/base station.

After a failure to receive response messages from the non-responsive base station, the user equipment may, in some example embodiments, also determine whether an estimated path loss between user equipment 114 and base station 110A is above or below a threshold value (which may be signaled or statically specified), and this determination may be used as a criteria for evaluating whether another cell/access point should be searched for and/or selected or the non-responsive cell may be barred with respect to frequency, radio access technology, and the like. Additionally or alternatively, the user equipment 114 may also determine a reference signal, received power (RSRP), a received signal strength indicator (RSSI), a reference signal received quality (RSRQ), and/or any other signal metric is above or below a certain threshold (which may be signaled or statically specified).

In some example embodiments, user equipment 114 may be configured by network/base station 110A (via, for example, broadcast or dedicated signaling) to detect base station non-responsiveness. Moreover, this configuration may also instruct user equipment 114 to bar a current cell, a current frequency, and/or a current radio access technology and/or re-select a cell, a frequency, and/or a radio access technology change after random access failure and/or a radio link failure is declared. By enabling the network/base station 110A to configure this detection and/or configuration, network/base station 110A may configure this detection and/or configuration in one or more cells but not in other cells (for example, in these other cells there may not be a problem with respect to the getting “stuck” in a cell as noted above, so the network/base station may instead want user equipment 114 to continue random accesses for a prolonged period rather than declaring a radio link failure and/or searching for another cell). Moreover, network/base station 110A may configure this detection and/or configuration on a per user equipment and/or per cell basis, in some example embodiments.

In some example embodiments, user equipment 114 may be configured to (instead of barring the cell) apply a cell, a frequency, and/or a radio access technology specific offset when detecting the non-responsive base station. In some example embodiments, the offset to applied may be increased as a function of failed random access channel (RACH) attempts.

In some example embodiments, user equipment 114 may be configured to adjust (for example, lower) the priority of the frequency and/or radio access technology when detecting a non-responsive base station.

In some example embodiments, user equipment 114 may be configured to add the non-responsive cell, frequency, and/or radio access technology to a so-called “blacklist” of cells, frequencies, and/or radio access technologies that should not be used. This list may be limited to a specific call and/or to a specific period of time. Moreover, barring or applying an offset, adjusting priority, or blacklisting may be applied until some predefined time has expired or some predefined condition have been met.

When the user equipment detects a non-responsive base station as disclosed herein, user equipment 114 may, in some example embodiments, bar a current cell, such as cell 112A, a current frequency associated with cell 112A, and/or a current radio access technology associated with cell 112A (and thus base station 110A), so that user equipment 114 can instead perform a cell, a frequency, and/or a radio access technology change after the random access failure and/or a radio link failure is declared. For example, user equipment 114 may, after detecting base station 110A as non-responsive to the random access attempts, declare a Radio Link Failure (RLF). When the RLF is detected, user equipment 114 may then be free to perform a cell change, a frequency change, and/or a radio access technology change by performing, for example, a scheduling request or a random access to another base station, such as base stations 110B-C and the like.

Before providing additional details regarding system 100, the following provides additional description of an example framework for system 100.

The base stations 110A-C may comprise a wireless access point, such as a cellular base station, an evolved Node B (eNB) type base station, and/or the like, with wired and/or wireless backhaul links to other networks and/or network nodes, such as for example, a mobility management entity, other base stations, a radio network controller, a core network, a serving gateway, and/or the like.

In some example embodiments, base station 110A may serve a macro cell, such as for example, a macrocell 112A; base station 110B may be implemented as a small cell base station serving small cell 112B; base station 110C may be implemented as a small cell base station serving small cell 112C, although other types of cells and base stations may be implemented as well.

When the evolved Node B (eNB) type base station is used, base station 110A may be configured in accordance with standards, including the Long Term Evolution (LTE) standards, such as for example, 3GPP TS 36.201, Evolved Universal Terrestrial Radio Access (E-UTRA), Long Term Evolution (LTE) physical layer, General description, 3GPP TS 36.211, Evolved Universal Terrestrial Radio Access (E-UTRA), Physical channels and modulation, 3GPP TS 36.212, Evolved Universal Terrestrial Radio Access (E-UTRA), Multiplexing and channel coding, 3GPP TS 36.213, Evolved Universal Terrestrial Radio Access (E-UTRA), Physical layer procedures, 3GPP TS 36.214, Evolved Universal Terrestrial Radio Access (E-UTRA), Physical layer—Measurements Protocol specification, 3GPP TS 36.331, Technical Specification Group Radio Access Network, Evolved Universal Terrestrial Radio Access (E-UTRA), Radio Resource Control (RRC), and any subsequent additions or revisions to these and other 3GPP series of standards (collectively referred to as LTE standards). Base station 110A may also be configured to serve cells using other radio technologies including WLAN technology, such as for example, WiFi (for example, the IEEE 802.11 series of standards. In some example implementations, base stations 110A is configured as an eNB base station serving a macrocell, and base stations 110B-C are implemented as a WiFi access points, although other types of base stations may be implemented as well.

In some example embodiments, user equipment 114 may be implemented as a mobile device and/or a stationary device. In some example embodiments, user equipment 114 may be implemented as a multi-mode user device configured to operate using a plurality of radio technologies. For example, user equipment 114 may be configured to operate using a plurality of radio access technologies including one or more of the following: Long Term Evolution (LTE), wireless local area network (WLAN) technology, such as for example, 802.11 WiFi and/or the like, Bluetooth, Bluetooth low energy (BT-LE), near field communications (NFC), and/or any other radio technology. Moreover, user equipment 114 may be configured to have established connections to base station via links (for example, uplinks and downlinks).

Although FIG. 1 depicts a specific quantity and configuration of base stations, cells, and user equipment, other quantities and configurations may be implemented as well. Although some of the examples disclosed herein refer to specific radio technologies, such as Long Term Evolution and UTRAN and the like, other radio access technologies including GERAN may be used as well.

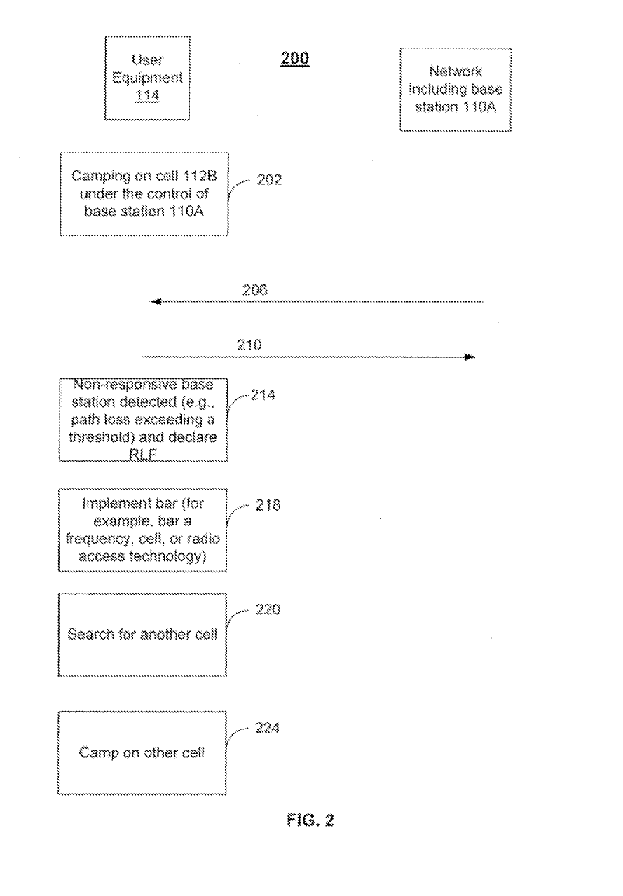

FIG. 2 depicts an example process 200 for barring at least one of a current frequency, a current cell, and/or a current radio access technology to prevent user equipment 114 from getting stuck on a cell when base station 110A does not respond to user equipment's 114 attempts to perform a random access to base station 110A, in accordance with some example embodiments.

At 202, user equipment may, in some example embodiments, camp on a cell, such as cell 112A, using a certain radio access technology, such as LTE and the like, and/or a certain frequency. This camping may be performed under the direction of base station 110A. For example, base station 110A may direct user equipment 114 to camp at cell 112A for a variety of reasons. However, base station 110A may be at a relatively long distance from user equipment 114 or not reachable by the user equipment 114 via uplink for some other reason. Consequently, user equipment 114 may be able to receive transmissions from base station 110A, but user equipment 114 may find itself unable to send to base station 110A sufficiently powerful transmissions to carry random access messages, so base station 110A may not receive those random access transmissions.

In some example embodiments, the network, such as base station 110A may, at 206, configure user equipment 114 to bar at least one of a current frequency, a current cell, and/or a current radio access technology by performing a frequency, a cell, and/or a radio access technology change after a random access failure or a radio link failure is declared at a current cell, such as cell 112A, due to a detection, as disclosed herein, of an unresponsive base station 110A. For example, if user equipment 114 determines an estimated path loss between user equipment 114 and base station 110A is larger than a predetermined threshold, user equipment 114 may perform a frequency change, a cell change, and/or a radio access technology change, rather than camp on cell 112A. For example, the user equipment 114 may change frequencies to search for cells and base stations other than cell 112A and base station 110A. Likewise, user equipment 114 may change radio access technologies to search for cells and base stations having radio technologies other than the radio access technologies currently active at cell 112A and base station 110A.

Although the previous example describes the network/base station 110A signaling (for example via broadcast signaling and the like) the user equipment to bar the current cell/frequency/radio access technology, this behavior at the user equipment 114 may be configured without signaling, such as by a default behavior.

At 210, data may become available for transmission to base station 110A, and user equipment 114 may start sending a random access request for connection establishment to base station 110A, in accordance with some example embodiments. However, base station 110A may, in some example embodiments, not receive the random access request from user equipment 114 (for example, due to path loss, distance between user equipment 114 and base station 110A, and the like).

At 214, user equipment 114 may detect a non-responsive base station condition, in accordance with some example embodiments. For example, user equipment 114 may, in some example embodiments, detect a non-responsive base station 110A as noted for example above. To illustrate, user equipment 114 may transmit a certain quantity of random access preambles, and if no response is received from the base station 110A, user equipment 114 may consider base station 110A as non-responsive and a radio link failure may be declared (when in a connected state). User equipment 114 may, in some example embodiments, estimate path loss between user equipment 114 and base station 110A, and if the estimated path loss exceeds a certain threshold (which may be signaled at 206 or configured in other ways), base station 110A may be considered non-responsive as it is likely to far from user equipment 114 to receive the random access attempts.

In some example embodiments, user equipment 114 may, based on the detection at 214, implement barring, at 218, with respect to a current frequency, a current cell, and/or a current radio access technology to prevent user equipment 114 from getting stuck on a cell 112A, when base station 110A does not respond to user equipment's 114 attempts to perform a random access to base station 110A. For example, user equipment 114 may bar use of a certain carrier frequency used to communicate with base station 110A, the use of cell 112A (for example, based on a cell identifier for cell 112A), and/or the use of a radio technology being used at cell 112A (or base station 110A). This barring may prevent user equipment 114 from getting stuck on a cell 112A and thus force user equipment 114 to search for another cell. However, the user equipment 114 may not perform the barring but instead simply reselect another cell, frequency, or radio access technology as described herein.

At 220, user equipment 114 may start searching for a cell, in accordance with some example embodiments. For example, user equipment 114 may search for another cell, another LTE carrier frequency, and/or another radio access technology until it finds a suitable cell, such as cells 112B and/or C served by base stations 110B-C at another carrier frequency (which is different from the barred frequency, cell 112A, and/or radio access technology).

At 224, user equipment 114 may start to camp on the cell identified at 220 and/or initiate a random access procedure for connection establishment to the identified cell, in accordance with some example embodiments. For example, user equipment 114 may identify at 220 cell 112C and base station 110C. In this example, user equipment 114 may camp on cell 112C and/or initiate a random access procedure for connection establishment to base station 110C to enable data transmission proceeds between user equipment 114 and base station 110C.

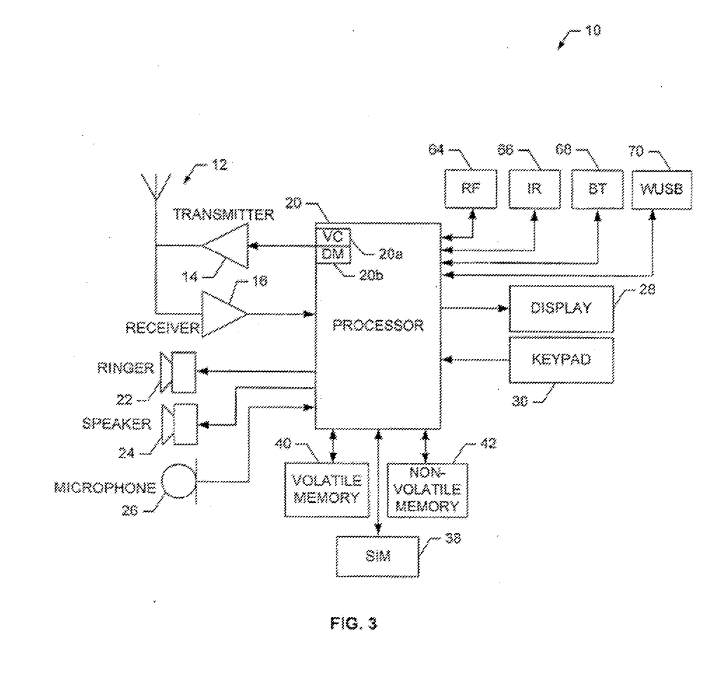

FIG. 3 illustrates a block diagram of an apparatus 10, which can be configured as user equipment in accordance with some example embodiments.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example, a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 3 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as for example, Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. Also, for example, the apparatus 10 may be capable of operating in accordance with 2.5G wireless communication protocols General Packet Radio Service. (GPRS), Enhanced Data GSM Environment (EDGE), and/or the like. Further, for example, the apparatus 10 may be capable of operating in accordance with 3G wireless communication protocols, such as for example, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as for example, Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as for example, LTE Advanced and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as for example, a web browser. The connectivity program may allow the apparatus 10 to transmit and receive web content, such as for example, location-based content, according to a protocol, such as for example, wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as for example, a keypad 30 (which can be a virtual keyboard presented on display 28 or an externally coupled keyboard) and/or other input devices.

As shown in FIG. 3, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as for example, an infrared (IR) transceiver 66, a Bluetooth (BT) transceiver 68 operating using Bluetooth wireless technology, a wireless universal serial bus (USB) transceiver 70, and/or the like. The Bluetooth transceiver 68 may be capable of operating according to low power or ultra-low power Bluetooth technology, for example, Wibree, radio standards. In this regard, the apparatus 10 and, in particular, the short-range transceiver may be capable of transmitting data to and/or receiving data from electronic devices within a proximity of the apparatus, such as for example, within 10 meters, for example. The apparatus 10 including the WiFi or wireless local area networking modem may also be capable of transmitting and/or receiving data from electronic devices according to various wireless networking techniques, including 6 LoWpan, Wi-Fi, Wi-Fi low power, WLAN techniques such as for example, IEEE 802.11 techniques, IEEE 802.15 techniques, IEEE 802.16 techniques, and/or the like.

The apparatus 10 may comprise memory, such as for example, a subscriber identity module (SIM) 38, a removable user identity module (R-UIM), and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the user equipment/mobile terminal. The memories may comprise an identifier, such as for example, an international mobile equipment identification (IMEI) code, capable of uniquely identifying apparatus 10. The functions may include one or more of the operations disclosed herein with respect to the user equipment, such as for example, the functions disclosed at process 200 (for example, activate the cellular modem and/or the like). The memories may comprise an identifier, such as for example, an international mobile equipment identification (IMEI) code, capable of uniquely identifying apparatus 10. In the example embodiment, the processor 20 may be configured using computer code stored at memory 40 and/or 42 to detect a non-responsive base station, search for another cell, and perform other operations as disclosed herein.

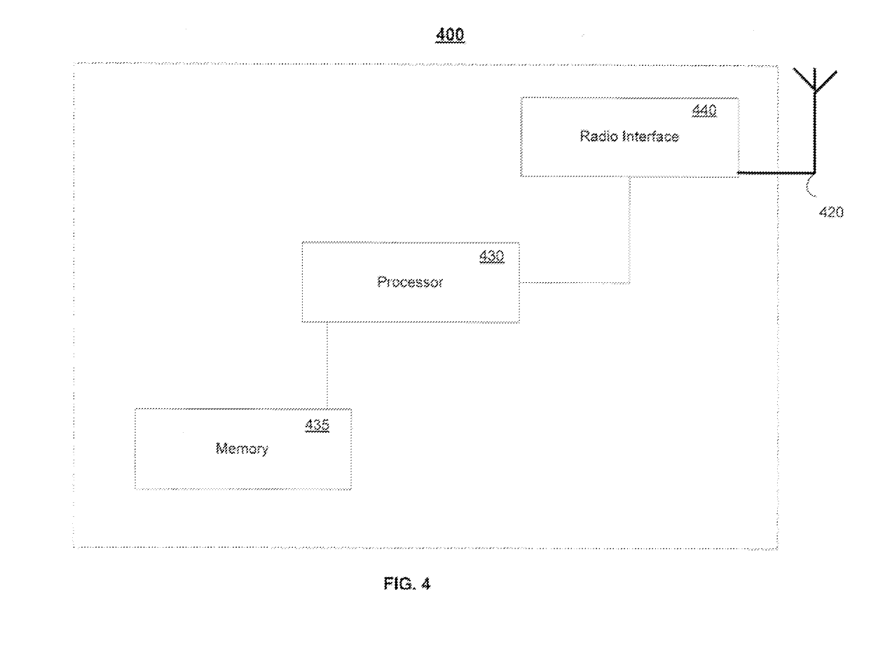

FIG. 4 depicts an example implementation of a network node 400, such as base stations 110A-C. The base station may include one or more antennas 420 configured to transmit via a downlink and configured to receive uplinks via the antenna(s) 420. The base station may further include a plurality of radio interfaces 440 coupled to the antenna 420. The radio interfaces may correspond one or more of the following: Long Term Evolution (LTE, or E-UTRAN), Third Generation (3G, UTRAN, or high speed packet access (HSPA)), Global System for Mobile communications (GSM), wireless local area network (WLAN) technology, such as for example 802.11 WiFi and/or the like, Bluetooth, Bluetooth low energy (BT-LE), near field communications (NFC), and any other radio technologies. The radio interface 440 may further include other components, such as filters, converters (for example, digital-to-analog converters and the like), mappers, a Fast Fourier Transform (FFT) module, and the like, to generate symbols for a transmission via one or more downlinks and to receive symbols (for example, via an uplink). The base station may further include one or more processors, such as processor 430, for controlling the access point 400 and for accessing and executing program code stored in memory 435. In some example embodiments, the memory 435 includes code, which when executed by at least one processor causes one or more of the operations described herein with respect to a base station. For example, the base station may configure a user equipment to bar a current cell, a current frequency, and/or a current radio access technology as noted above, although the base station may be configured to provide any other operations associated with the network or base station disclosed herein.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as for example, a computer or data processor, with examples depicted at FIGS. 3 and 4. A computer-readable medium may comprise a non-transitory computer-readable storage medium that may be any media that can contain or store the instructions for use by or in connection with an instruction execution system, apparatus, or device, such as for example, a computer. And, some of the embodiments disclosed herein include computer programs configured to cause methods as disclosed herein (see, for example, process 200 and/or the like).

Without in any way limiting the scope, interpretation, or application of the claims appearing below, a technical effect of one or more of the example embodiments disclosed herein is preventing the user equipment from getting stuck on a camped cell due to an imbalance in the uplink and downlinks caused by the base station being at a relatively long distance from the user equipment (or some other like effect impacting path loss).

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of the present invention as defined in the appended claims. Other embodiments may be within the scope of the following claims. The term “based on” includes “based on at least.”

1-29. (canceled)

30. A method comprising:
detecting, by a user equipment camped on a cell, a non-responsive base station with respect to a random access procedure performed by the user equipment;
enabling the user equipment to search for another cell, rather than remaining camped on the cell; and
barring from the search at least one of a frequency associated with the cell, the cell, or a radio access technology associated with the cell for a predetermined period of time.

31. The method of claim 30, wherein the user equipment is configured to perform the barring based on at least one of signaling received from a network or a default configuration.

32. The method of claim 30 further comprising:
searching, by the user equipment, for the another cell using at least one of another frequency or another radio access technology.

33. The method of claim 30, wherein the detecting further comprises:
detecting that the non-responsive base station fails to respond to a transmission by the user equipment of at least one random access request.

34. The method of claim 33, wherein the detecting the non-responsive base station further comprises:
determining at least one of the following: whether a predetermined quantity of random access requests sent to the non-responsive base station fails to result in a response from the non-responsive base station; whether the non-responsive base station fails to respond to random access messages after a predetermined duration; and whether a path loss estimate between the user equipment and the non-responsive base station exceeds a predetermined threshold.

35. The method of claim 30, wherein the user equipment performs a search for another cell, another frequency, another radio access technology, or a combination thereof, when the non-responsive base station does not response to one or more random access requests transmitted by the user equipment.

36. The method of claim 30, wherein the user equipment performs a search for another cell, another frequency, another radio access technology, or a combination of thereof, when a measurement associated with the non-responsive base station exceeds a threshold value, wherein the measurement represents at least one of a reference signal received power, a received signal strength indication, or a reference signal received quality.

37. The method of claim 30, wherein the user equipment performs a search for another cell, another frequency, another radio access technology, or a combination thereof, when a network configures the user equipment to perform the search after a random access failure with the non-responsive base station.

38. The method of claim 30, wherein the user equipment is enabled to perform a search for another cell by at least applying an offset for a received signal quality metric for a predetermined time.

39. An apparatus comprising:
at least one processor; and
at least one memory including computer program code, the at least one memory and the computer program code configured to, with the at least one processor, cause the apparatus to perform at least the following:
detect, by the apparatus camped on a cell, a non-responsive base station with respect to a random access procedure performed by the apparatus; enable the apparatus to search for another cell, rather than remaining camped on the cell; and
bar from the search at least one of a frequency associated with the cell, the cell, or a radio access technology associated with the cell for a predetermined period of time.

40. The apparatus of claim 39, wherein the apparatus is configured to perform the barring based on at least one of signaling received from a network or a default configuration.

41. The apparatus of claim 39, wherein the apparatus is further configured to perform the search for the another cell using at least one of another frequency or another radio access technology.

42. The apparatus of claim 39, wherein the apparatus is further configured to detect the non-responsive base station when the base station fails to respond to a transmission by the apparatus of at least one random access request.

43. The apparatus of claim 42, wherein the at least one memory and computer program instructions are further configured to, with the at least one processor, cause the apparatus to determine at least one of the following: whether a predetermined quantity of random access requests sent to the non-responsive base station fails to result in a response from the non-responsive base station; whether the non-responsive base station fails to respond to random access messages after a predetermined duration; and
whether a path loss estimate between the apparatus and the non-responsive base station exceeds a predetermined threshold.

44. The apparatus of claim 39, wherein the apparatus performs a search for another cell, another frequency, another radio access technology, or a combination thereof, when the non-responsive base station does not response to one or more random access requests transmitted by the apparatus.

45. The apparatus of claim 39, wherein the apparatus performs a search for another cell, another frequency, another radio access technology, or a combination of thereof, when a measurement associated with the non-responsive base station exceeds a threshold value, wherein the measurement represents at least one of a reference signal received power, a received signal strength indication, or a reference signal received quality.

46. The apparatus of claim 39, wherein the apparatus performs a search for another cell, another frequency, another radio access technology, or a combination thereof, when a network configures the apparatus to perform the search after a random access failure with the non-responsive base station.

47. The apparatus of claim 39, wherein the apparatus is enabled to perform a search for another cell by at least applying an offset for a received signal quality metric for a predetermined time.

48. The apparatus of claim 39, wherein the apparatus is enabled to perform a search for another cell by at least adjusting a priority of the cell.

49. A non-transitory computer-readable storage medium including computer code, which when executed by at least one processor provides operations comprising:
detecting, by a user equipment camped on a cell, a non-responsive base station with respect to a random access procedure performed by the user equipment;
enabling the user equipment to search for another cell, rather than remaining camped on the cell; and
barring from the search at least one of a frequency associated with the cell, the cell, or a radio access technology associated with the cell for a predetermined period of time.
